(19) United States
(12) Patent Application Publication
(10) Pub. No.: US 2003/0106440 A1
(43) Pub. Date: Jun. 12, 2003

(54) J-Extractor

(76) Inventor: Vernon Lee Nelson, Stone Mountain, GA (US)

Correspondence Address: Vernon L. Nelson, 4454 Cypress Ridge Lane, Stone Mountain, GA, 30083, US

(21) Appl. No.: 10/007,962

(22) Filed: Dec. 10, 2001

(51) Int. Cl. B30B 9/06; B30B 1/18

(52) U.S. Cl. 100/110; 100/125; 100/289

(57) ABSTRACT

The concept of the “J-Extractor” is that of a newly designed utensil for extracting water or oil from tuna. The “J-Extractor” would be a hand-held straining device specifically designed to remove excess water and/or oil from tuna. The device would consist of a strainer pan with incorporated drain holes and a twist-lock lid with an attached turn handle and pressing plate. The contents of a can of tuna would be placed into the pan and the lid attached, with the user then turning the device's top-mounted handle to lower the internal press plate and extract water/oil from the tuna. The use of the “J-Extractor” would allow the user to remove excess water and/or oil from tuna in a quick and efficient manner, eliminating the possibility of spilling the liquids onto the hands or a countertop. The device would be extremely easy to use and could be washed either by a dishwasher or by hand.

The present invention is that of a newly designed utensil for extracting water or oil from tuna or other foods. The present invention comprises a bottom strainer pan with bottom-mounted drain holes, an internal pressing plate, a twist-lock lid with a side-mounted attached handle, and a top-mounted rotating turn handle.

The bottom strainer pan would have a plurality of drain holes on its bottom face. The pan would preferably be circular, and would have a raised edge. An attached handle would extend outward from the raised edge. The top of the raised edge would contain a plurality of locking tabs that would be used for a twist-lock mechanism similar to those used on a standard-type pressure cookers.

The internal pressing plate would be circular and would include a top-mounted threaded spindle or rod. The threaded spindle or would be joined to the tope of the pressing plate in a ball and socket joint, insuring that the press plate does not turn as the pressing plate is raised and lowered.

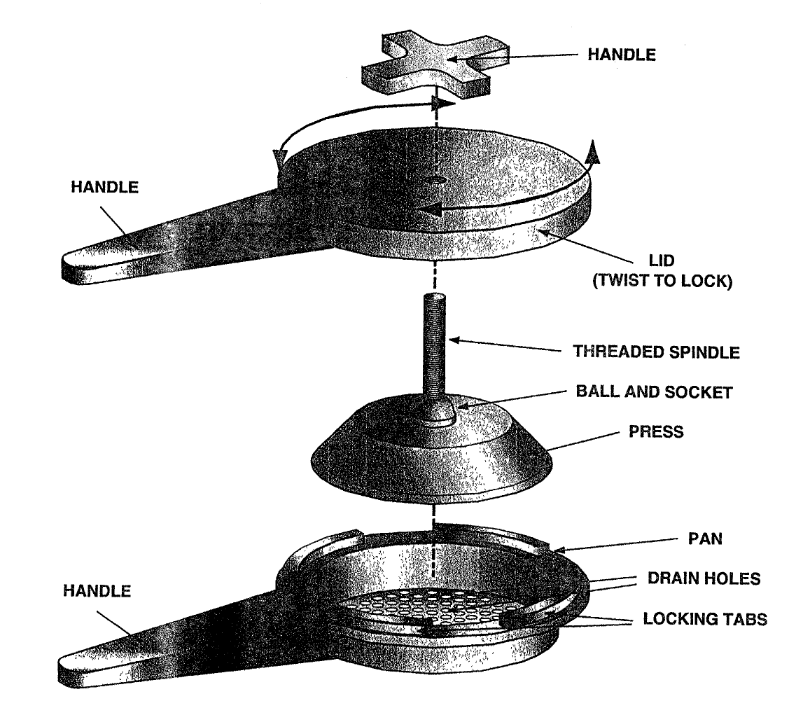

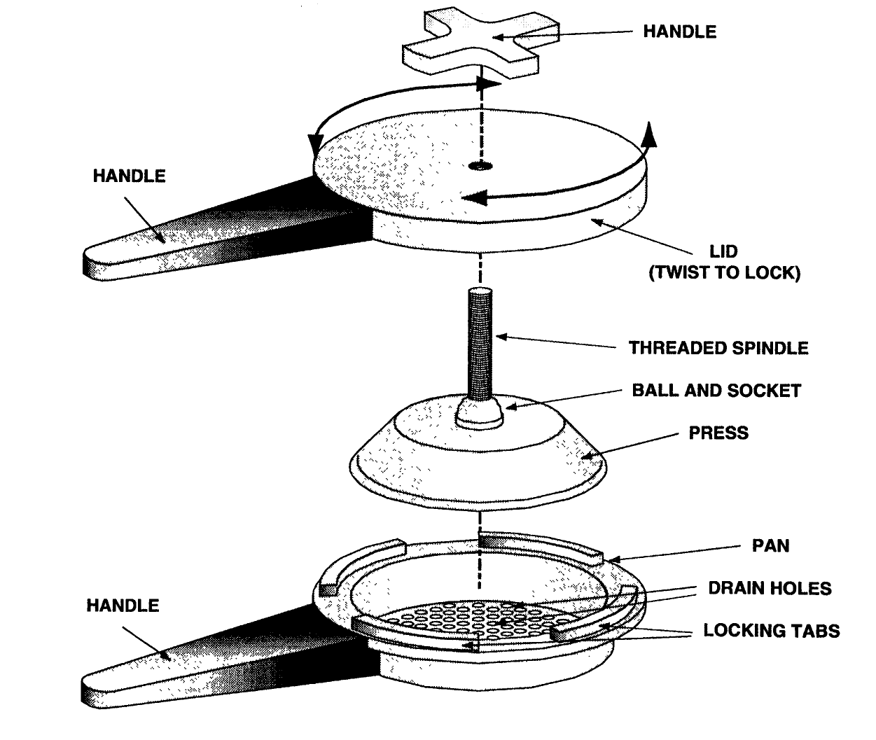

The twist lock lid would be a flat circular device with an attached handle similar in configuration to the handle on the bottom strainer pan. The lid would contain a plurality of locking tabs that would be fixedly attached to the bottom surface around the perimeter. The twist-lock lid would include a centrally located hole so that the top-mounted threaded spindle or rod could be placed through the twist-lock lid. Once this would be accomplished, the top-mounted rotating turn handle would be attached to the threaded spindle or rod. The rotating turn handle would then be continually turned, thereby forcing the twist lock lid and internal pressing plat down onto any food contents located within the bottom strainer pan. The present invention and all of its incorporated parts can be seen in a perspective view in FIG. 1.

Use of the present invention would allow a user to remove excess water and/or oil from tuna and other food products in a quick and efficient manner, eliminating the possibility of spilling the liquids onto the hands or a counter top. The device would be extremely easy to use and could be washed either by a dishwasher or by hand.

The present invention would be fabricated from stainless steel and plastic. As an option, the present invention could be used for crushing and/or straining all types of fruits, vegetables, fish, or other food products. In use, a user would simply place the contents of a can of tuna or other food product into the strainer pan of the present invention. The user would then place the internal pressing plate on top of the food product, and then secure the present invention's lid in a locked position. The top-mounted rotating turn handle would then be used to lower the internal press plate and extract the excess water or oil from the food product. The water or oil would exit the strainer through the incorporated drain holes, into a sink or garbage can. Once the food product would be strained, the user would raise the press plate and unlock the lid in order to access the food product. The present invention would be very convenient and easy to use, allowing a user to drain food product in a matter of seconds, with little or no mess. The present invention would be completely dishwasher safe and would be easy to store.

1. Invention Function: The concept of the “J-Extractor” is that of a newly designed utensil for extracting water or oil from tuna.

2. Specific, Unique Function or Property of Invention: The “J-Extractor” would be a hand-held straining device specifically designed to remove excess water and/or oil from tuna. The device would consist of a strainer pan with incorporated drain holes and a twist-lock lid with an attached turn handle and pressing plate. The contents of a can of tuna would be placed into the pan and the lid attached, with the user then turning the device's top-mounted handle to lower the internal press and extract water/oil from the tuna.

3. Invention Features: The “J-Extractor” would feature a durable, stainless steel construction, a twist-lock lid with a top-mounted turn handle, an internal pressing plate, extended carrying handles on both the strainer and the lid (which would align when the device is secured in a closed position), incorporated drain holes, and locking tabs similar to those used on standard type pressure cookers. The device would be dishwasher safe.

4. Invention Benefits: Use of the “J-Extractor” would allow the user to remove excess water and/or oil from tuna in a quick and efficient manner, eliminating the possibility of spilling the liquids onto the hands or a countertop. The device would be extremely easy to use and could be washed either by a dishwasher or by hand.

5. Invention Variations: As an option, the “J-Extractor” could be used for crushing and/or straining all types of fruits, vegetables, fish, etc.

6. Inventor's Suggested Material and Components: The J-Extractor” would be fabricated from stainless steel and plastic.

7. Inventor's Comments Concerning Invention: I have a 9-year-old son whose favorite food is tuna. After watching my wife tiring to separate the water from the tuna, it gave me the idea of a device that would make it easier to do. I came up with the concept of a hand-held strainer with a pressure-applying knob that will remove the water from the tuna. And the J-Extractor” is something I have not seen on the market.

8. Mechanical Description: The “J-Extractor” would be a hand-held straining device fabricated from stainless steel. The device would consist of a strainer pan with incorporated drain holes, and a twist-lock lid similar to those used on standard-type pressure cookers. The lid would be aligned with locking tabs on the strainer pan, then twisted and locked in a closed position. Both the lid and the pan would have attached plastic handles which would align when the device is closed. The lid would also have an attached pressing place, with a turn handle on the tope of the lid connected to a threaded spindle or rod at the top of this press, positioned below the lies. The threaded spindle would be joined to the top of the press at a ball and socket joint, ensuring that the press plate does not turn as the press is raised and lowered. As an option, the “J-Extractor” could be used for crushing and/or straining all types of fruits, vegetables, fish, etc.

9. Usage: In use, the user would place the contents of a can of tuna into the strainer pan of the “J-Extractor”, then secure the device's lid in a locked position. The top-mounted turn handle would then be used to lower the internal press plate and extract the excess water or oil from the tuna. The water or oil would exit the strainer through the incorporated drain holds, into a sink or garbage can. Once the tuna is strained, the user would raise the press plate and unlock the lid in order the access the tuna. The “J-Extractor” would be very convenient and easy to use, allowing the user to drain tuna in a matter of seconds, with little or no mess. The device would be completely dishwasher safe.
